(19) United States
(12) Patent Application Publication
(10) Pub. No.: US 2010/0043850 A1
(43) Pub. Date: Feb. 25, 2010

(54) Apparatus for Cleaning Golf Accesories, in Particular Golf Clubs and Golf Balls

(76) Inventor: Waldemar Kiener, Lauchheim (DE)

Correspondence Address: KRIEGSMAN & KRIEGSMAN, 30 TURNPIKE ROAD, SUITE 9, SOUTHBOROUGH, MA, 01772, US

(21) Appl. No.: 11/918,081

(22) PCT Filed: Jul. 28, 2005
(86) PCT No.: PCT/EP2005/008215

§ 371 Date: Aug. 28, 2009

(30) Foreign Application Priority Data
Apr. 8, 2005 (DE) 10 2005 016 471.4

(51) Int. Cl. B08B 3/12

(52) U.S. Cl. 134/184

(57) ABSTRACT

The invention relates to an apparatus for cleaning golf accessories, in particular golf clubs and golf balls, having a housing (12) for accommodating at least one cleaning unit (16) which comprises a cleaning container (21) which can be filled with a cleaning liquid, and having ultrasound generators (29) which are associated with the cleaning container (21) and generate ultrasound waves in a cleaning liquid which is located in the cleaning container, with a spraying unit (41) being provided above a liquid level of the cleaning liquid in the cleaning unit (16), the said spraying unit forming a spray curtain which extends at least partially over the surface of the cleaning liquid in the cleaning container (21).

The invention relates to an apparatus for cleaning golf accessories, in particular golf clubs and golf balls, according to the preamble of Claim 1.

WO 99/34874 discloses an apparatus for cleaning golf accessories, which apparatus has a housing for accommodating at least one cleaning unit. This cleaning unit comprises a cleaning container which is filled with a cleaning liquid. Ultrasound sonotrodes, which generate ultrasonic waves in the liquid in the cleaning container in order to clean the golf accessories, are provided on the cleaning container.

Particles of dirt which mostly adhere to the club face can be largely detached by an ultrasonic cleaning process. The ultrasonic waves disperse the particles of dirt removed from the club face, as a result of which the cleaning liquid is soiled. In particular, particles of earth are broken up to a greater or lesser extent in the cleaning liquid. After the cleaning process, the clubs are removed from the cleaning liquid. One disadvantage of this is that the dirty cleaning liquid adheres to the club which has been cleaned by the cleaning process, as a result of which the cleaning is only limited. When the dirty cleaning liquid dries, a white-grey film is found on the club. This does not provide complete cleaning.

The object of the invention is therefore to provide an apparatus for cleaning golf accessories, which apparatus permits complete cleaning of the golf accessories.

According to the invention, this object is made possible by an apparatus which comprises a spray unit above a liquid level of the cleaning liquid in the cleaning unit, which spray unit generates a spray curtain at least partially above the surface of the cleaning liquid. As a result, it is possible to automatically spray-off the golf accessories, in particular the club face of a golf club, after the club has been cleaned by ultrasonic waves in the cleaning liquid, when the club is removed from the cleaning container. Particles of dirt which are dispersed in the cleaning liquid and can adhere to the club when it is removed are sprayed-off and removed by the spraying-off process. The cleaning result for the golf accessories is therefore substantially increased.

Provision is advantageously made for the spray unit to comprise at least one spray nozzle. As an alternative, provision can be made for at least one surge nozzle or a flat spray nozzle to be provided in order to form the spray curtain.

The at least one spray nozzle preferably has a jet angle of at least 30°. A plurality of spray nozzles are preferably arranged next to one another so that the jet angles overlap at least in sections. This permits a virtually completely closed spray curtain to be formed in the cleaning unit in order to ensure complete spraying-off of the item of golf accessories, which is located in the cleaning liquid, when the said item is removed.

The spray nozzles for forming the spray unit are preferably oriented horizontally or inclined in relation to the liquid level in the cleaning container. As a result, it is possible to ensure that the user is not wetted by the spray liquid during removal of the golf accessories.

The spray nozzles are preferably separately supplied via a fresh-water connection. As a result, the spray curtain or the fresh water can be dispensed at the pressure provided in a public supply mains. If the water for supplying the spray nozzles is provided by a cistern, a pump can preferably be provided in the apparatus for cleaning golf accessories, in order to produce the spray curtain. In addition, an increased jet pressure can be generated by a pump.

The spray curtain formed by the spray nozzles is preferably formed after the ultrasonic cleaning. The end of cleaning is preferably indicated to the user by means of a signal, for example a light signal and/or an audible signal. The spray nozzles are supplied with fresh water at this time at the latest, so that additional cleaning-off is performed when the cleaning unit is unloaded by the user.

The duration of the spray process is preferably controlled in terms of time. This can be provided by a predetermined time period or by means of a sensor which switches off the supply of fresh water to the spray unit after the last item of golf accessories to be cleaned has been removed from the cleaning unit.

The spray nozzles can advantageously be used for subsequent cleaning of a cleaning container. For example, the spray nozzles can be actuated after all the cleaning liquid has flowed out of the cleaning container, as a result of which the cleaning container is sprayed down, so that residual particles of dirt can be transported out of the cleaning container. For this purpose, the spray nozzles can be provided opposite one another on the wall sections of the cleaning container, in particular on each wall section. In addition, the spray nozzles can be pivotably mounted and in particular designed so as to be driven by the jet pressure. In order to produce a spray curtain, spray nozzles can be supplied with fresh water on only one or on a plurality of wall sections. It goes without saying that all the spray nozzles which are provided in the cleaning unit can also be actuated in order to dispense fresh water.

According to a further advantageous refinement of the invention, provision is made to provide at least one air nozzle in the cleaning unit, in particular above the spray nozzles. As a result, the drops of liquid adhering to the golf accessories can be blown off, as a result of which the golf accessories is simultaneously dried. As an alternative, a spray gun by means of which manual drying is possible can likewise be connected to the apparatus and initialized.

The air nozzles are preferably supplied with compressed air. This compressed air can be provided by a compressor which is arranged in the housing or a separate compressed-air line. The air curtain is preferably actuated and formed in an analogous manner to the spray curtain.

According to a further advantageous refinement of the invention, the cleaning unit has an inlet valve in a supply line to the cleaning container and an outlet valve in an outlet line from the cleaning container, it being possible for a control unit to actuate the said inlet valve and outlet valve. As a result, the cleaning liquid can be automatically replaced after a predetermined number of cleaning operations or after a specific period of use. Sensors which monitor the filling of the cleaning container and/or the filling level are preferably provided.

The inlet valve in the supply line to the cleaning container is preferably in the form of a mixer valve through which fresh water and cleaning agent additives can be supplied to the cleaning container. The mixer valve can preferably be in the form of a Venturi nozzle, so that it is possible to ensure that a percentage of cleaning agent additives are admixed during filling of the cleaning container and also during refilling of the cleaning container. Further metering options or mixing operations which depend on the supply of liquid are possible.

According to one preferred embodiment, the outlet valve provided is a clamping valve. In this case, a hose clamping valve is used in particular. This has the advantage that it is not sensitive to particles of dirt which are being discharged. Furthermore, this clamping valve does not require maintenance and has a self-cleaning effect, in particular when subsequently rinsing the cleaning container. A clamping mechanism is preferably actuated by motor and constricts and blocks the cross section of the discharge line.

For reliable operation of the apparatus, the invention further provides for a housing closure means which is of pivotable design to be provided on the housing. As a result, the number of moving parts is considerably reduced. This leads to an increase in service life and a simplification in structure. The housing closure means of the apparatus is unlocked after clearance for use of the cleaning unit. This clearance for use can be provided either by inserting a token or by checking a use-authorization means in the form of an identification card which comprises a magnetic strip or a chip module and, in particular, can be checked in a contact-free manner. Unlocking releases the housing closure means for opening purposes. This ensures that damage, misuse or wilful soiling of the device when it is not in operation is prevented. The closure means is manually opened after unlocking. In particular embodiments, the said closure means can also be automatically opened by a motorized drive.

The housing closure means is retained in an opened state by a retaining device. This retaining device is activated after the clearance for use of the apparatus and automatically locks the housing closure means when it assumes an opened end position. The retaining device may be in the form of an electromagnetic coupling, a retaining magnet or an electrically releasable locking means.

After loading of the cleaning unit with the golf accessories, the retaining device can be either manually unlocked or automatically unlocked after a sensor detects complete filling.

The housing closure means preferably closes the housing opening on account of its inherent gravitational force. To this end, provision is made for a centre of gravity of the housing closure means to be outside its axis of rotation.

In order to avoid injuries, provision is advantageously made for the housing closure means to execute a closing movement in a manner decelerated by damping means. The damping means may be frictional elements or spring elements which decelerate the closing movement. As an alternative, paddles or resistance elements can also be provided which dip into the cleaning liquid and decelerate the movement.

The cleaning process by means of ultrasonic cleaning is preferably started when the housing closure means has assumed a closed position. This closed position can be detected by a sensor by checking the angular position of the housing closure means, for example using an instrumental transmitter, or by, for example, a lug which is arranged on the housing closure means interrupting a light barrier or operating a proximity switch. Equally, end position switches or proximity switches can be provided for detecting the closed position.

The cleaning unit preferably contains at least one sensor, in particular a light barrier, which checks for the presence of golf accessories, in particular a golf club. In one embodiment of the housing, provision is made for the shaft and the handle of the club to protrude out of an opening which is to be closed by the housing closure means. When a golf club which is positioned in the cleaning container is identified, a closed position is identified when the housing closure means rests against the shaft of the club, and the cleaning process is enabled. This can be detected by a sensor strip on the housing closure means or by correspondingly adjusted light barriers or end position sensors which identify this position of the housing closure means.

In addition, the housing closure means can be arrested in this position and be released again only after cleaning is complete.

The individual steps during cleaning and/or use of the cleaning apparatus can be indicated by means of a display on the front face of the housing and/or by an audible signal. The display also has associated key elements in order to start, stop or interrupt the cleaning procedure.

The invention and further advantageous embodiments and developments of the said invention are described and explained in greater detail in the text which follows with reference to the examples illustrated in the drawings. According to the invention, the features contained in the description and the drawings can be applied individually or together in any desired combination. In the drawings:

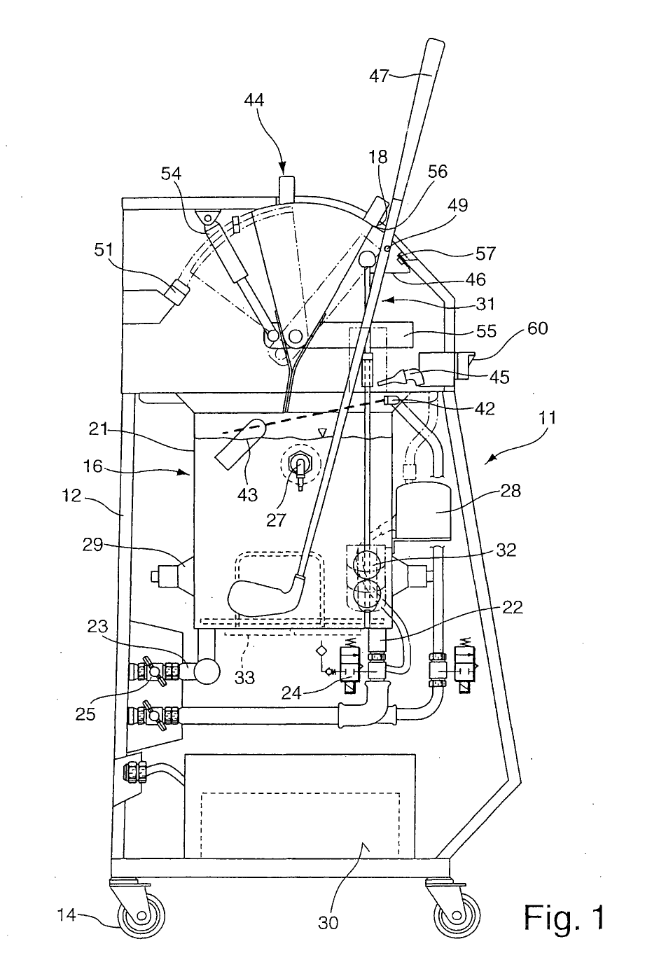

FIG. 1 shows a schematic side view of the apparatus according to the invention,

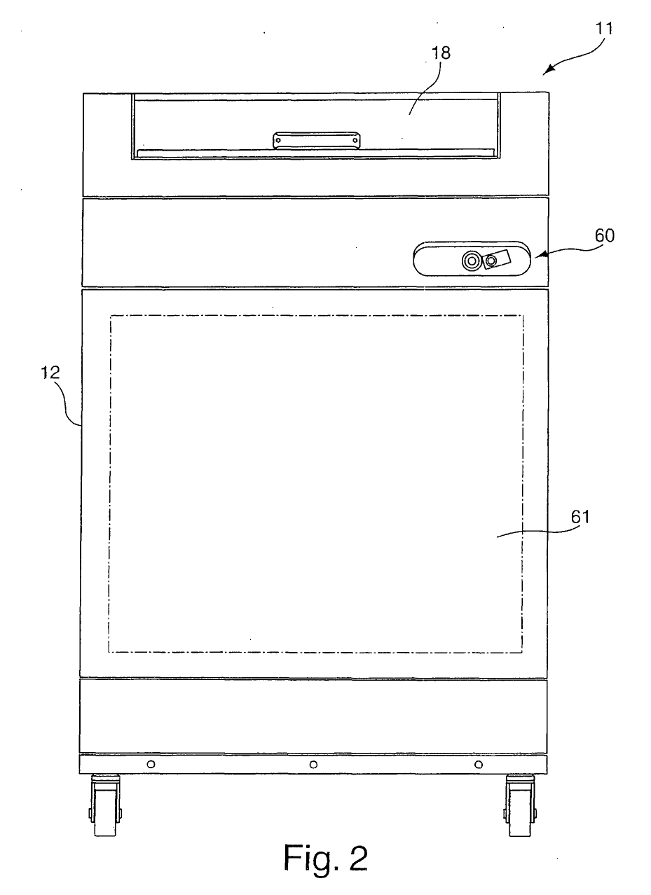

FIG. 2 shows a schematic front view of the apparatus according to the invention, and

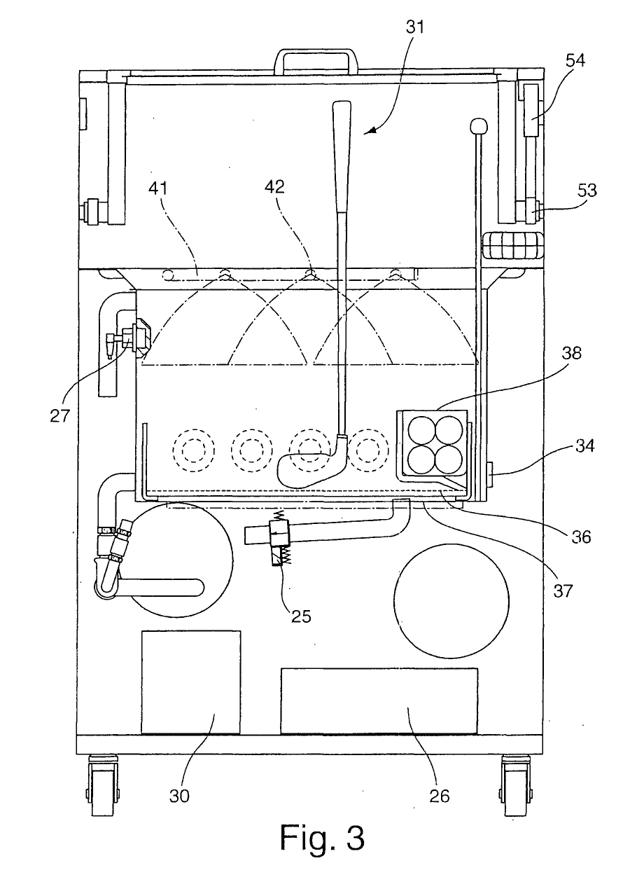

FIG. 3 shows a schematic partial view of the cleaning unit with a spray curtain.

FIG. 1 illustrates a schematic side view of an apparatus 11 according to the invention for cleaning golf accessories, in particular golf clubs and golf balls. FIG. 2 shows a front view of the apparatus 11. The apparatus 11 comprises a housing 12 which, for example, is provided on rollers 14 in order to make the apparatus 11 mobile. As a result, the apparatus 11 can be easily moved to wintering quarters or be easily set up at the desired location for events. As an alternative, fixed and vertically adjustable feet can be provided.

The housing 12 comprises a cleaning unit 16 which is accessible after the housing closure means 18 is opened. The cleaning unit 16 comprises a cleaning container 21 which is filled with a liquid, in particular cleaning liquid, via a supply line 22 and is emptied via a discharge line 23. In order to fill the cleaning container, a supply valve 24, which can be actuated by means of a control unit 26, is provided in the supply line 22. The supply line 22 is supplied with fresh water which is provided by the public mains or by means of a cistern. In addition, cleaning agent additives from a reservoir container 28 are admixed via the supply valve 24. The said supply valve may be in the form of a valve with a Venturi nozzle or an adjustable mixer valve. Filling of the cleaning container 21 is monitored by means of filling-level sensors 27, so that the supply valve 24 is automatically switched off after the cleaning container 21 is completely filled. At the same time, the liquid level in the cleaning container 21 can also be regulated as a result of the said monitoring.

Furthermore, the cleaning container 21 has, on one or more wall sections, ultrasound sonotrodes 29 which are operated by an ultrasound generator 30 and generate ultrasonic waves in the liquid in the cleaning container 21 in order to clean golf accessories, in particular golf clubs 31 and/or golf balls 32. In order to carry out the cleaning operation, the cleaning liquid is heated, for example to from 30° to 40°. To this end, a panel heater 33 is preferably provided and is provided on a lower face of the cleaning container 21 or can also be provided in sections on side wall sections. A temperature sensor 34 not only controls heating of the liquid but also prevents overheating since fresh water is supplied.

The cleaning container 21 contains a lattice or basket 36 which holds a golf club at a distance from the base 37 of the cleaning container 21. As a result, the removed particles of dirt can sink to the base and a plurality of cleaning cycles are possible without cleaning of the golf club 31 being prevented by particles of dirt accumulating on the base 37. The lattice 36 is inserted into the cleaning container 21 and can be removed as required. In addition, a lattice 38 can advantageously be inserted into the cleaning container 21 by means of a sliding guide for holding golf balls 32 or can be pivoted into the cleaning liquid by means of a pivoting arrangement, so that it is possible to easily remove the individual golf balls 32 after cleaning.

As an alternative, baskets, which are arranged on a chain, for holding one or more golf balls can be provided, it being possible to insert the baskets into and remove the baskets from the cleaning container 21 as desired.

The cleaning liquid and the cleaning container 21 can be replaced as a function of the number of cleaning operations or after a certain time period. This can be detected and actuated by the control unit 26. The inlet valve 24 and the outlet valve 25 are accordingly opened. The outlet valve 25 is preferably configured in such a way that, despite particles of dirt being entrained in the cleaning liquid, complete closing is possible. For example, a clamping valve which does not require maintenance and has a self-cleaning effect can be provided. A rotary closure means or a clamping closure means, which reduces the cross section of the line to zero, can block the said valve by means of actuation of a motor.

The cleaning container 21 can additionally be provided with an overflow 43, so that cleaning liquid which is additionally introduced above a predefined liquid level can flow away. As a result, cleaning conditions which are always the same can be provided for the ultrasound sonotrodes 29.

The cleaning unit 16 also has a spray unit 41 which is illustrated in detail in FIG. 3. The spray unit 41 comprises at least one spray nozzle 42 which has a jet angle of at least 30°, preferably 90°. A spray curtain, which extends over the entire liquid surface or the access region when golf accessories is introduced into the cleaning unit 16, can be created by a plurality of spray nozzles 42 which are arranged on one or more side walls of the cleaning container 21. The spray nozzle 42 is supplied with fresh water. A spray curtain is preferably formed without additional pressure. The spray nozzle 42 is preferably provided horizontally or inclined with respect to the liquid, so that the dispensed liquid is not sprayed and scattered by the spray nozzles 42 when the golf accessories is removed. The golf accessories which is removed from the cleaning liquid can therefore be washed down and cleaned by the spray nozzles 42 too.

The formation of the spray curtain means liquid is additionally introduced into the cleaning container 21. The liquid which passes a specific liquid level can flow away through the overflow 43, or the outlet valve 21 is automatically opened in order to maintain a predetermined liquid level. As a result, it is simultaneously possible for the cleaning liquid to have a relatively low degree of soiling.

An air curtain is preferably formed above the spray curtain by at least one air nozzle 45.

The base 37 of the cleaning container 21 is preferably inclined, so that the sediments which have accumulated on the base are automatically discharged when the liquid is replaced. In addition, the spray nozzles 42 can dispense fresh water, so that subsequent cleaning can be performed by means of the spray nozzles 42 after all the cleaning liquid has been expelled. As a result, the discharge valve 25 can also be self-cleaned.

The cleaning unit 16 is accessible after a housing closure means 18 for loading and unloading golf accessories is opened. As a result, wilful soiling of the cleaning unit 16 or damage to the interior of the housing is prevented.

The housing closure means 18 can be completely locked in a closed position. This closure means can be unlocked by user identification means. User identification may take the form of insertion of a token or be provided by an identification card which is identified by a card-reading system which is provided in the housing 12. For example, a magnetic-strip reader or a memory-chip checking system or contact-free checking of the system (RFID system) may be provided. After the housing closure means 18 is unlocked, the user can move the housing closure means 18 to an open position 44. The cleaning unit 16 is accessible, and the golf accessories can be inserted.

In one embodiment, provision is made for the shaft of the club to rest against a bearing face 46 or bearing edge of the housing opening, with the handles 47 protruding out of the housing 12. The bearing face 46 may take the form of a rack with rounded accommodation sectors for holding the shafts separately. In another embodiment, the golf clubs 31 can be arranged completely in the housing 12.

The inserted golf accessories can be identified by a sensor 49. This may be performed, for example, by a light barrier or a switching strip or a plurality of proximity switches or the like. After identification of the golf accessories having been positioned or after operation of a key by the user, a retaining device 51 which has retained the housing closure means 18 in an open position 44 is released or unlocked. The housing closure means 18 pivots about an axis of rotation 53 on account of its inherent gravitational force and/or on account of a counterweight 55. In addition, a damping means 54 in the form of a spring element or frictional elements can perform a decelerated closing movement.

The cleaning process is carried out, that is to say the ultrasound sonotrodes 29 generate ultrasonic waves, after a closed position 56 is assumed. In the embodiment in which the golf clubs 31 are provided completely in the housing 12, the closed position 56 can be identified by it being identified that the housing closure means 18 rests against a sealing edge 57 or by a lug interrupting a light barrier. In the case of golf clubs 31 which protrude out of the housing 12, the closed position 56 is identified by a light barrier likewise identifying the presence of the golf clubs 31.

After ultrasonic cleaning, which is limited in terms of time, the spray unit 21 is supplied with fresh water. This can be combined with the end of the cleaning process or be actuated when the housing closure means 18 is opened. This ensures that a spray curtain is produced when the cleaning unit 16 is unloaded, and the golf accessories is additional rinsed after removal from the cleaning liquid and freed from dirty cleaning liquid.

After the golf accessories has been completely removed, the housing closure means 18 is closed by locking the retaining device 51, and possibly additionally locked. The complete removal of the golf accessories is monitored by a light barrier. In addition, a timer circuit can be provided which automatically closes the housing 12 and locks the housing closure means 18.

An indicator and operator control display 60 is provided on the lower face of the housing 12. This display can indicate the individual states of the apparatus. By navigating through a menu, the user can track the course of the working steps or actively intervene using key elements. A slot for tokens, IC cards or magnetic-strip cards or an area for the contact-free transmission of data can be provided in the indicator and operator control display, depending on the payment and identification system used.

On a front face and possibly on its side walls, the housing 12 preferably has flat and closed areas 61 which can be used as advertising areas. In addition, the housing closure means 18 can have advertising areas.

Access authorization for use of the apparatus 11 for cleaning the golf accessories can be integrated in a club membership card. In addition, separate cards can be issued by individual sponsors, the said cards either being provided with credit or generally providing permission for use. In addition, a standard system for all apparatuses 11 can be provided, so that use is possible irrespective of the site of installation of the said apparatus.

Furthermore, the control unit 26 can advantageously be provided with a connection for remote data transmission, as a result of which remote checking and remote maintenance and state checking are possible, in order to ensure correct operation. In particular, replacement of the cleaning liquid and addition of cleaning agents can be checked here.

All the abovementioned features of the apparatus are essential to the invention and can be combined with one another in any desired manner.

1. Apparatus for cleaning golf accessories, in particular golf clubs and golf balls, having a housing for accommodating at least one cleaning unit which comprises a cleaning container which can be filled with a cleaning liquid, and having ultrasound generators which are associated with the cleaning container and generate ultrasonic waves in a cleaning liquid which is located in the cleaning container, and placing the golf clubs after positioning them in the cleaning container on a bearing face of the housing opening or completely in the housing, characterized in that a spray unit which forms a spray curtain which extends over the surface of the cleaning liquid in the cleaning container comprises at least one spray nozzle which is provided above a liquid level of the cleaning liquid in the cleaning unit and in that above the at least one spray nozzle at least one air nozzle is provided, and compressed air is supplied to the at least one air nozzle, so that an air curtain is formed above the cleaning container and the spray curtain.

2. (canceled)

3. Apparatus according to claim 1, characterized in that the spray nozzle comprises at least one jet angle of at least 30°, and a plurality of spray nozzles are provided relative to one another such that their jet angles are provided so as to overlap at least in sections.

4. Apparatus according to claim 1, characterized in that the at least one spray nozzle is oriented horizontally or inclined in relation to the liquid level.

5. Apparatus according to claim 1, characterized in that the at least one spray nozzle is provided to dispense fresh water.

6. Apparatus according to claim 1, characterized in that the at least one spray nozzle for dispensing fresh water is controlled after the end of the ultrasonic cleaning operation.

7. Apparatus according to claim 1, characterized in that the spraying process is controlled such that it is limited in terms of time.

8. Apparatus according to claim 1, characterized in that the at least one spray nozzle is controlled for subsequent cleaning of an emptied cleaning container.

9. (canceled)

10. (canceled)

11. Apparatus according to claim 1, characterized in that the cleaning unit has at least one supply valve which is arranged in a supply line, and a discharge valve which is arranged in a discharge line which leads away from the cleaning container, it being possible for a control unit to actuate the said discharge valve.

12. Apparatus according to claim 11, characterized in that the inlet valve is in the form of a mixer valve through which fresh water and cleaning agent additives can be supplied to the cleaning container.

13. Apparatus according to claim 11, characterized in that the outlet valve provided is a clamping valve.

14. (canceled)

15. (canceled)

16. (canceled)

17. (canceled)

18. (canceled)

19. (canceled)

20. (canceled)

21. (canceled)
